(19) United States
(12) Patent Application Publication
(10) Pub. No.: US 2020/0016984 A1
(43) Pub. Date: Jan. 16, 2020

(54) RECHARGEABLE BATTERY SYSTEM AND METHOD

(71) Applicant: Paul Mantea, Beverly Hills, CA (US)

(72) Inventor: Paul Mantea, Beverly Hills, CA (US)

(21) Appl. No.: 16/033,155

(22) Filed: Jul. 11, 2018

(51) Int. Cl. B60L 11/18; H01M 2/10; H01M 10/44; H02J 7/00

(52) U.S. Cl. CPC B60L 11/1838; H02J 7/0027; H01M 10/44; H01M 2/1083

(57) ABSTRACT

A system and method for providing charged rechargeable batteries is disclosed. The system may include a charging facility, a transport system and a battery exchange station. The charged batteries may be used with electric vehicles. The system may also include a mount to secure the rechargeable batteries to the electric vehicles.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

The current invention generally relates to rechargeable batteries, and in particular to a system and method for charging, deploying, exchanging, tracking, receiving, controlling, refurbishing, maintaining, redeploying and repurposing rechargeable batteries for use with electric vehicles. The current invention also relates to user data collection and data analysis.

### BACKGROUND OF THE INVENTION

It is a well-known fact that modern society is moving away from the use of combustible fuels and towards the use of more sustainable sources of energy. For example, the use of electric vehicles has become very popular.

However, the electric vehicles currently on the market are mainly designed for personal transportation, and as such, do not adequately serve the commercial goods transportation industries. In addition, the commercial goods transportation industry involves transporting goods over long distances (sometimes across the entire country), and as such, there is no infrastructure to allow for the recharging and/or exchanging of drained batteries for newly recharged batteries as the transportation vehicles travel across long distances.

It is desirable, and an object of this invention, to provide a system that will provide a turn-key solution for the charging, transporting, deployment, exchanging, tracking, receiving, recharging, refurbishment and redeployment of rechargeable batteries for use in the commercial goods transportation industries.

### BRIEF DESCRIPTION OF THE DRAWINGS

Various other objects, features and attendant advantages of the present invention will become fully appreciated as the same becomes better Understood when considered in conjunction with the accompanying drawings, in which like reference characters designate the same or similar parts throughout the several views, and wherein:

FIG. 1 depicts aspects of a framework for providing rechargeable batteries according to exemplary embodiments hereof;

FIG. 2 depicts aspects of a rechargeable battery according to exemplary embodiments hereof;

FIG. 3 depict aspects of a rechargeable battery mount according to exemplary embodiments hereof;

FIG. 4 depict aspects of a rechargeable battery and a battery mount according to exemplary embodiments hereof;

FIG. 5 depict aspects of a vehicle configured with a rechargeable battery according to exemplary embodiments hereof;

FIG. 6 depict aspects of a rechargeable battery moving apparatus according to exemplary embodiments hereof;

FIG. 7 depict aspects of a rechargeable battery charging facility according to exemplary embodiments hereof;

FIG. 8 depict aspects of a rechargeable battery transport system according to exemplary embodiments hereof; and

FIG. 9 depicts aspects of computing according to exemplary embodiments hereof.

### DETAILED DESCRIPTION OF THE PREFERRED EMBODIMENTS

As used herein, Unless used otherwise, the following term has the following meaning:

A “mechanism” refers to any device(s), process(es), routine(s), service(s), or combination thereof. A mechanism may be implemented in hardware, software, firmware, using a special-purpose device, or any combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered to be shorthand for the term device(s) and/or process(es) and/or service(s).

The following detailed description is not intended to limit the current invention. Alternate embodiments and variations of the subject matter described herein will be apparent to those skilled in the art.

### Overview

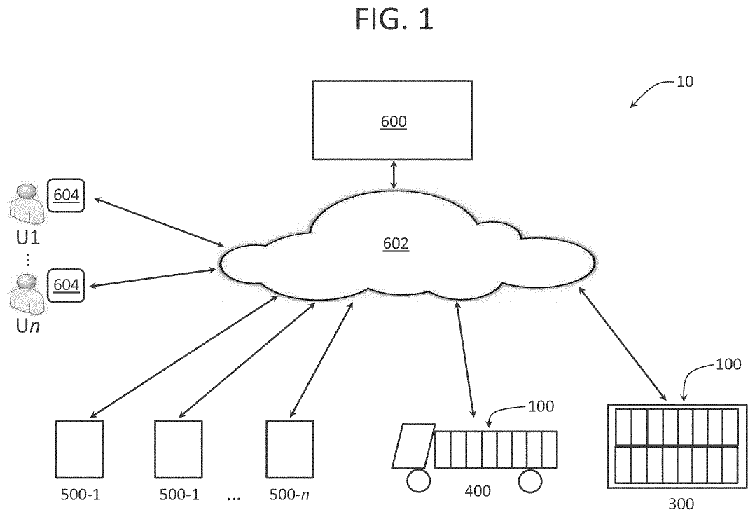

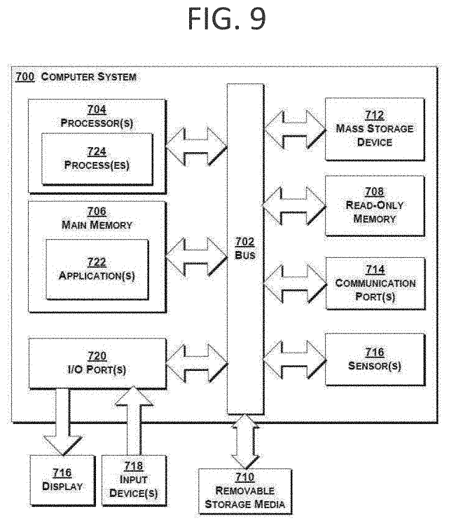

A system or framework 10 according to exemplary embodiments hereof is described here with reference to the drawings of FIGS. 1-9. Where the same or similar components appear in more than one figure, they are identified by the same or similar reference numerals.

In general, the system 10 may generally manufacture, store, transport, deploy, track, receive, charge, re-charge, exchange, refurbish, maintain, redeploy, dispose of and generally control and oversee all aspects of one or more rechargeable power sources, rechargeable power source charging facilities, rechargeable power source exchange facilities, rechargeable power supply transport systems, rechargeable power supply mounting assemblies, control platforms and other elements pertaining to the system 10 for use for a variety of different purposes in a variety of different industries.

In one exemplary embodiment hereof as shown in FIG. 1, the system 10 may include a rechargeable power supply 100, a rechargeable power supply mounting assembly 200, a power supply recharging and maintenance facility 300, a power supply transport system 400, a power supply exchange facility 500 and a control platform 600. The system 10 may also include other elements and components necessary to perform its functionalities as described in later sections. It is clear and Understood by a person of ordinary skill in the art that the system 10 may include one or more of each of the elements 200, 300, 400, 500 and 600.

In one exemplary implementation hereof, the rechargeable power supply 100 may include a rechargeable battery 100. As is known in the art, a battery is a device that is able to store electrical energy in the form of chemical energy, and convert that energy into electricity. The electricity may then be used to power electrical devices. Other types of rechargeable power supplies 100 such as hydrogen cells may also be used and are contemplated in this specification.

In one exemplary embodiment hereof, the system 10 may be implemented as a system 10 in support of the electric vehicle industry, and the rechargeable battery 100 may include an electric-vehicle battery (EVB) (also referred to as a traction battery). The EVB 100 may be used to generally provide energy to power the propulsion of a battery electric vehicle (BEV) 102.

As described in later sections, the BEV 102 may include a semi-trailer truck (e.g., a class 8 truck or any other appropriate class). The semi-trailer truck 102 may include a battery mounting assembly 200 that may generally mount, secure and otherwise configure the EVB 100 to the truck 102. It may be preferable that the battery 100 be easily installed to and removed from the mounting assembly 200 as required and as described in later sections.

As is known in the art, as a rechargeable battery 100 may be used to provide power of propulsion to an electric vehicle 102, the amount of energy stored in the battery 100 may diminish. As the stored energy continues to diminish with use, the battery 100 may reach a threshold of too little stored energy to sufficiently power the vehicle 102. This low energy battery may be generally referred to as drained. It is Understood however that the term drained may also be used to refer to the state of the battery 100 that may not yet be completely depleted of enough energy to sufficiently power an electric vehicle, but that may be approaching such a state of depletion. It is appreciated that the term drained may be generally subjective depending on the user, and that some users may view a battery 100 approaching complete depletion of stored energy as drained while other users may only view a battery completely depleted of stored energy as drained. For the purpose of this specification, the term drained may refer to a battery 100 that may be viewed as in general need of energy replenishment by its user (e.g., recharging) whether or not the battery 100 may be completely depleted of stored energy. For the purpose of this specification, a generally charged battery 100 may be denoted by the reference numeral 100A and a generally drained battery 100 may be denoted by the reference numeral 1008. The reference numeral 100 may denote a charged battery 100A, a drained battery 100B, or any combination thereof.

The system 10 may include a plurality of battery exchange centers 500 that users of BEVs 102 may visit to exchange their generally drained batteries 100B for generally charged batteries 100A (preferably fully charged). That is, as a user's battery 100 becomes low on stored energy, the user may visit an exchange center 500 to turn in their low energy battery 100B in return for a high energy battery 100A (e.g., for a fully charged battery 100A). In this way, the users of the BEVs 102 may utilize and enjoy the system 10 by which they may be ensured to have continuous and convenient access to adequately charged power supplies 100 for their vehicles 102.

The system 10 may also include a plurality of charging facilities 300 that may charge and provide maintenance to the drained batteries 1008. The transport system 400 may generally transport newly charged batteries 100A from the charging facilities 300 to the exchange stations 500 in order to keep the exchange centers 500 stocked with an adequate supply of charged batteries 100A for their customers. The transport system 400 may also transport drained batteries 100B (e.g., the batteries 100B turned in by the customers) from the exchange stations 500 to the charging facilities 300 for recharging and/or general maintenance. Note that the transport system 400 may also transport charged batteries 100A directly to end users of BEVs 102 as necessary. This will be described in later sections.

The system 10 may also include a control platform 600 that may generally control a variety of aspects of the batteries 100, the charging stations 300, the transport system 400 and the exchange stations 500. The control platform 600 may include a cloud platform (also referred to as a backend) that may receive data from and send data to the batteries 100, the charging stations 300, the transport system 400, the exchange stations 500 and the users of the BEVs 102 and system 10. A mobile application (mobile app) may also be included that may allow the users and the operators of the system 10 to receive and send data to and from the control platform 600. This will be described in later sections.

### The Rechargeable Power Supply

In one exemplary embodiment hereof, the rechargeable power supply 100 may include an electric-vehicle battery (EVB). The EVB 100 may include any type or any combination of types of rechargeable batteries, including but not limited to: lead-acid, nickel-cadmium (NiCd or NiCad), nickel-metal hydride (NiMH or Ni-MH), lithium-ion (Li-ion or LIB), Li-ion polymer, zinc-air, molten-salt batteries or any other types or combinations of types of rechargeable batteries.

As is known in the art, the amount of electrical energy (i.e. electric charge) stored in the EVB 100 may be measured in ampere hours (AH or amp hour), in coulombs or in other Units of electric charge. An ampere hour may be defined as the amount of energy charge in a battery that may allow one ampere of current to flow for one hour. An ampere is a Unit of measure of the rate of electron flow or current in an electrical conductor. A coulomb be may be defined as a Unit of charge equal to the quantity of electricity conveyed in one second by a current of one ampere.

The power supply 100 (e.g., the EVB) may be a battery pack 100 that may include one or more individual batteries 100 connected in series, in parallel or in any combination thereof. It may be preferable that the EVB 100 include a high ampere hour capacity, a high power-to-weight ratio, a high energy to weight ratio and a high energy density.

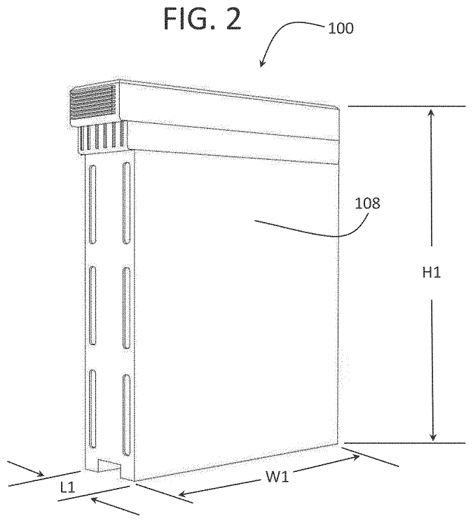

In one exemplary embodiment, the rechargeable battery pack 100 may include a housing 108 as shown in FIG. 2. The battery housing 108 may generally enclose, encase, cover, protect and adequately contain the various elements of the battery pack 100 such as the individual batteries that may comprise the battery pack 100, the battery cells, the electrical and physical connections between the batteries, the electrical and physical connections between the cells, cooling mechanisms for the battery 100, and any other components and/or elements that may be necessary for the battery 100 to perform its functionalities. For the purposes of this disclosure and Unless specified as otherwise, reference to the battery pack 100 may be Understood to include the battery pack's associated battery enclosure 108, and reference to the battery enclosure 108 may be Understood to include the battery enclosure's associated battery pack 100.

As will be described in later sections, the battery enclosure 108 may be held secure and may be generally attached to a BEV 102 by the mounting assembly 200.

Accordingly, the battery pack 100 (including its enclosure 108) may be physically configured with the BEV 102. In addition, the battery pack 100 may also be electrically connected to the BEV 102. In one exemplary embodiment hereof, the battery pack 100 may be physically and electrically configured with a semi-trailer truck 102. As shown in FIG. V, the semi-trailer truck 102 may generally include a cabin 106, a chassis 108, and a storage container 110. The chassis 108 of the truck 102 may generally include the main support structure of the truck 102 and may provide support to the cabin 106, the wheels, the motor, the storage container 110 as well as other components of the truck 102.

The battery pack 100 and the semi-trailer truck 102 may include corresponding electrical connectors that may mate to electrically connect the battery pack 100 to the truck 102 when the battery pack 100 is configured within the mounting assembly 200 on the truck 102. For example, the battery enclosure 108 may include at least one positive terminal (e.g., a cathode terminal) and at least one negative terminal (e.g., an anode terminal) that may be electrically configured with the positive and negative terminals respectively of the truck's electric motor and/or electrical system. In this way, the battery pack 100 may provide energy to the motor to propel the truck 102. Note that the battery pack 100 may also be electrically configured with and provide energy to other elements of the truck 102 such as the truck's electrical system that may power the truck's lights (e.g., the headlights, the brake lights, the reverse lights, the fog lights, the parking lights, the interior cabin lights, and other types of lights), the dashboard readouts, the radio, and any other system or components of the truck 102 that may require electricity to operate.

The truck 102 and the battery pack 100 may also be electrically connected via wireless power transfer (WPT) (also referred to as wireless power transmission, wireless energy transmission or electromagnetic power transfer). In this case, the electrical energy of the battery pack 100 may be transferred to the truck 102 via magnetic fields using inductive coupling between corresponding metal coils on the truck 102 and the battery pack 100, or by electric fields using capacitive coupling between corresponding metal electrodes on the truck 102 and the battery pack 100. In this way, it may not be necessary for the battery enclosure 108 to include physical electrical connectors that may be accessible from the exterior of enclosure 108. Note also that the system 10 may utilize both physical electrical connections and wireless power transfer, or any combination thereof to transfer energy from the power supply 100 to the truck 102.

As shown, the battery housing 108 may have a width W1, a length L1 and a height H1. In one exemplary embodiment hereof, it may be preferable that the height H1 be greater than the length L1 such that the battery 100 may stand generally upright as shown. This may allow for the battery 100 to be stored upright such that its physical footprint may be minimized. Note however that other heights, lengths and widths may also be used are contemplated in this specification.

It is Understood by a person of ordinary skill in the art that different battery packs 100 may be used for different applications (e.g., for different electric vehicles), and that the different battery packs 100 need not match in dimension, size, shape, weight or form. It is also Understood that the different battery packs 100 may include different stored energy capacities, different output energy specifications, different charging specifications, and that the electrical specifications of the different battery packs 100 need not match.

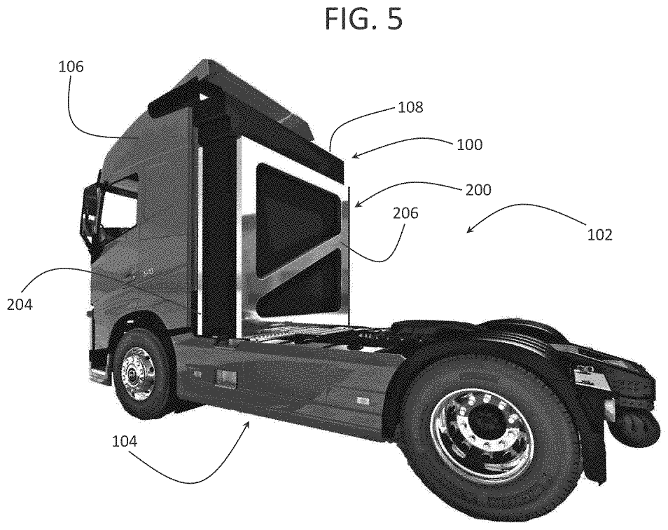

In one exemplary embodiment, as mentioned above, it may be preferable for the battery 100 including the battery enclosure 108 to be generally positioned vertically (i.e., upright) behind the cabin 106 of the electric truck 102. This is shown in FIG. 5 and will be described in more detail in later sections. It may also be preferable that the battery 100 be generally supported on or by the chassis 104 of the truck 102, on or by a support member that may be on or supported by the chassis 104 of the truck 102, or any combination thereof. This may ensure that the weight of the battery 100 be adequately supported by the truck 102. This will be described in later sections. Note also that other orientations and locations of the battery and the battery enclosure 108 with respect to the truck 102 may also be used and are contemplated in this specification.

The enclosure 108 may comprise metal such as aluminum or steel, hard plastic, composite materials, or any other material or any combinations thereof.

### The Mounting Assembly

In one exemplary embodiment hereof, the mounting assembly 200 may generally include a mount or support structure that may mount, secure, hold, support and generally configure the battery pack 100 to the truck 102.

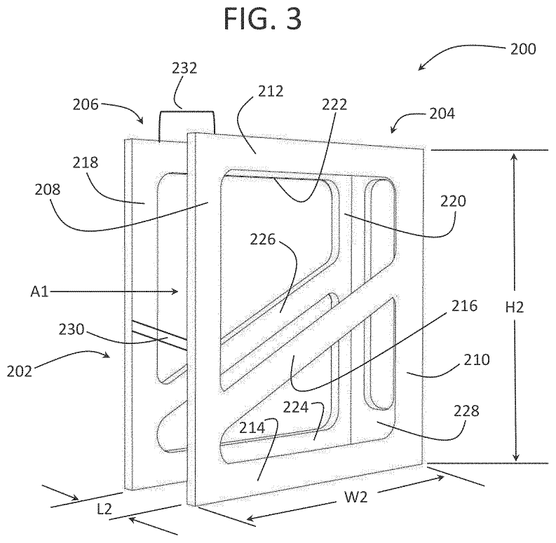

In one exemplary embodiment hereof, the mounting assembly 200 may include a frame 202 that may receive the battery enclosure 108. In one preferred implementation as shown in FIG. 3, the frame 202 may include a front support structure 204 and a rear support structure 206. The front support structure 204 may include a left support structure 208 that may be generally upright, a right support structure 210 that may be generally upright, a top support structure 212 that may generally extend from the upper portion of the left structure 208 to the upper portion of the right structure 210, and a bottom support structure 214 that may generally extend from the bottom portion of the left structure 208 to the bottom portion of the right structure 210. A cross support structure 216 may generally extend from the left upright section 208 to the right upright section 210. In one preferred embodiment, the cross support structure 216 may be positioned diagonally from the left structure 208 to the right structure 210, but it is clear that any number of cross support structures 216 may be configured at any angle or orientation.

Similarly, rear support structure 206 may include a left support section 218 that may be generally upright, a right support structure 220 that may be generally upright, a top support structure 222 that may generally extend from the upper portion of the left structure 218 to the upper portion of the right structure 220, and a bottom support structure 224 that may generally extend from the bottom portion of the left structure 218 to the bottom portion of the right structure 220. One or more cross support structures 226 may generally extend from the left upright section 218 to the right upright section 220. In one preferred embodiment, one or more cross support structure 226 may be positioned diagonally from the left structure 218 to the right structure 220 as shown, but it is understood that any number of cross support structures 226 may be configured at any angle or orientation.

The front frame section 204 and the rear frame section 206 may be generally configured to form the frame 202 by positioning the front frame section 204 in front of the rear frame section 206 (preferable directly in front) so that the sections 204, 206 may be aligned (e.g., may mirror one another). The respective left structures 208, 218, the right structures 210, 220, the top structures 212, 222, the bottom structures 214, 224 and the cross sections 216, 226 may be parallel and generally aligned as shown in FIG. W. In this generally parallel alignment, the frame sections 204, 206 may be spaced apart by a distance L2. In this way, an internal area A1 between and defined by the front and rear frame sections 204, 206 may be formed. Note that the front frame 204 and the rear frame 206 may be attached and held secure in this general configuration by side frame structure(s) as will be describe in later sections. In addition, the front and rear frame sections 204, 206 need not necessarily be aligned in a parallel configuration as described, but may be aligned in any formations or orientations that may allow for the battery 100 to be configured and secured within the frame 200.

The mounting assembly 200 may also include a bottom structure upon which the battery 100 may rest. The bottom structure may generally extend from the lower portion of the front frame 204 to the lower portion of the rear frame 206, and the battery 100 may rest upon the bottom structure. In another embodiment, the battery 100 may rest on the top of the chassis 104, on any other support structure that may be configured with the chassis 104 and/or the mounting assembly 200, or in any combination of structures.

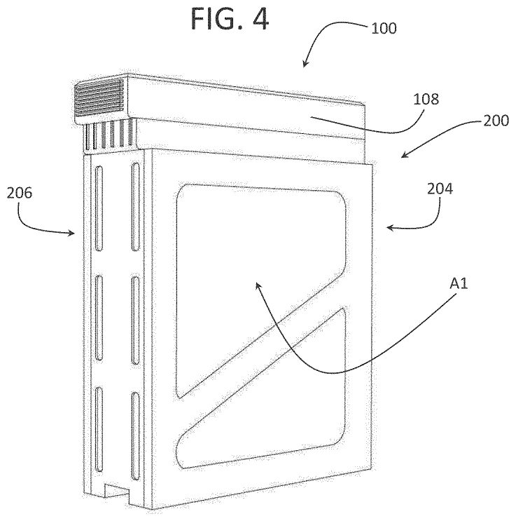

As shown in FIG. 4 and according to one exemplary embodiment hereof, the battery enclosure 108 may be received into the area A1 between the front and rear frame sections 104, 106. It may be preferable that the spacing L2 between the front and rear frame sections 204, 206 be slightly larger than the length L1 of the battery enclosure 108. In this way, the battery enclosure 108 may fit within the area A1 between the front and rear frame sections 104, 106. In addition, with the battery enclosure 108 received into the area A1, it may be preferable that the enclosure 108 fit generally snug within the area A1 of the frame 202 and that the front and rear frame sections 204, 206 may provide vertical support to the enclosure 108. The front and rear frame sections 204, 206 may come into physical contact with the corresponding sides of the enclosure 108 such that the sides of the enclosure 108 may generally abut against the inner surfaces of the front and rear frame sections 204, 206. However, this may not be necessary.

With the battery pack 100 configured within the mounting assembly 200, the battery pack 100 and the truck 102 may be electrically connected as described in prior sections of this specification.

The frame 202 may include guide rails, slots or other types of guiding mechanisms that may engage with elements of the enclosure 108 to generally guide and position the enclosure 108 within the frame 202 as desired. For example, the frame 202 may include top and bottom lips that may engage with the top and bottom edges of the battery enclosure 108 respectively when the battery enclosure is 108 is placed into the frame 202. The guide mechanisms may include small guide wheels or other mechanisms that may allow for the easy movement of the battery 100 into the space A1. The guide mechanisms may also provide additional support to the battery enclosure 108 and may prevent the battery enclosure 108 from moving freely in any direction within the frame 202. Other types or combinations of types of guiding mechanisms may also be used.

It may be preferable that the width W1 of the battery enclosure 108 generally fit within the width W2 of the frame 202. It may also be preferable that the upright frame sections 108, 210, 218, 220 overlap at least a portion of the battery enclosure 108 such that the sections 108, 210, 218, 220 may provide vertical and lateral support thereto. As shown, the cross sections 216, 226 may also overlap a portion of the enclosure and provide both vertical and lateral support to the enclosure 108 when the enclosure 108 is configured within the mounting assembly 200.

The height H2 of the frame 202 may be less than, equal to or greater than the height H1 of the battery enclosure 108. If the height H2 is less than the height H1 of the battery 100, it may be preferable the height H2 be great enough to adequately support the battery enclosure 108 within the frame 202 such that the battery enclosure 108 may not inadvertently fall out of the frame 202 while the truck 102 is in operation.

In one exemplary embodiment, the left and right sides of the frame 202 may be generally open to allow the battery enclosure 108 to be received into the frame and subsequently removed from the frame 202 through either open side. That is, a freshly charged battery pack 100 may be installed into the frame 202 to be utilized by the truck 102, and then removed from the frame 202 when the battery 100 may be drained of stored energy. A freshly charged battery pack 100 may then be installed into the frame 202 to provide energy to the truck 102.

In one exemplary embodiment hereof, the frame 202 may include at least one side section 228 that may at least partially obstruct the left and/or the right sides of the area A1. In one implementation, either the left side or the right side of the frame 202 may include the side section 228, but not both. In this way, the side section 228 may close or generally block one side of the frame 202 so that the battery pack 100 may not be installed into or removed from the frame 202 from that side. In one implementation, the side section 228 may extend between the front and rear frame sections 204, 206 on the right or left of the frame 202 as shown. While the side section 228 is shown in FIG. 3 as obstructing at least a portion (e.g., the upper and lower portions) of the right side of the area A1, the side section 228 may instead (or also) be configured with the left side of the frame such that it may at least partially obstruct the left side of the area A1. In this way, the side structure 228 may prevent the battery enclosure 108 from falling out or being removed (either purposely or unintentionally) from the side of the frame 202 that may include the structure 228. Note that the structure 228 may be adapted to be removed, moved, opened, or otherwise repositioned so that the battery enclosure 108 may be removed from the side of the frame 202 that may include the structure 228. If this is the case, it may be preferable that the structure 228 include a locking mechanism or other type of device that may ensure that the structure 228 may not be opened inadvertently. However, this may not be necessary.

With the side structure 228 generally preventing the battery enclosure 108 from being removed from one side of the frame 202, the other side of the frame 202 may not necessarily include a side obstructing structure 228. In this way, the battery enclosure 108 may be removed from the unobstructed side. In this case however, it may be preferable that the frame 202 include a locking mechanism 230 on the unobstructed side that may releasably lock the battery enclosure 108 within the frame 202 when the battery enclosure 108 is installed. The locking mechanism 230 may include one or more latches, beams, locks, rods, gates, locking pins, walls, or other types or any combinations of types of securing, obstructing or locking structures 230 that may ensure that the battery enclosure 108 remain secure within the frame 202 and not be removed from the side of the frame 202 Unintentionally or inadvertently.

To remove the battery enclosure 108 from the frame 202, the locking mechanism 230 may be Unlocked and/or opened, and the battery enclosure 108 may be removed from the frame 202. This may allow for easy installation and removal of the battery 100 to and from the truck 102 as will be described in later sections. The specific methods of removal will be described below.

It is appreciated that either or both sides of the frame 202 may include a locking structure 230 and that if both sides include a locking structure 230, it may not be necessary for either side to include a side section 228. In addition, if both sides of the frame 202 include a locking structure 230 and not a side section 228, the battery enclosure 108 may be installed into and removed from the frame 202 from either side.

The mounting assembly 200 may also include a top locking mechanism 232 that may generally extend from the upper region of the front frame section 204 to the upper region of the rear frame section 206. When the battery enclosure 108 may be installed within the frame 202, the top locking mechanism 232 may generally extend over the top of the battery enclosure 108 to provide an upper stop to the battery enclosure 108. In this way, the battery enclosure 108 may be prevented from moving upward within the frame 202. The top locking mechanism 232 may include latches, straps, locking pins, beams, rods or other locking structures or any combination thereof. Note also that the top locking mechanism 232 may not be required and that the battery pack 100 may be secured vertically within the frame 202 by other means (e.g., by guide mechanisms, by the weight of the battery pack 100 or by other securing mechanisms or combinations of securing mechanisms).

In any event, it may be preferred that while configured within the frame 202, the battery 100 may be held secure and stable. It may also be preferable that the battery enclosure 108 be held by the frame 202 relatively tight so that the battery enclosure 108 may not move freely within the frame 202. For example, it may be preferable that the battery enclosure 108 not rattle, vibrate or generally move side-to-side, up and down, or in any other direction or combination of any directions while configured with the frame 202. In this way, the battery 100 may be held secure and safe within the frame 202.

The frame 202 and/or the battery enclosure 108 may also include padding and/or shock absorber mechanisms that may dampen vibrations that may travel from the truck 102 to the frame 202. In this way, vibrations created by the truck 102 while being driven may be dampened such that the vibrations may not cause harm or damage to the battery pack 100.

In one exemplary embodiment hereof, the mounting assembly 200 may be generally positioned on the chassis 104 of the truck 102 and secured thereto. The mounting assembly 200 may be attached to the chassis 104 of the truck 102 by bolts, welding, latches, clamps, pressure fit or by any other attachment mechanisms or combinations of attachment mechanisms. In this way, the frame 202 and the battery 100 configured within the frame 202 may be securely configured with and supported by the chassis 104 of the truck 102.

In one exemplary embodiment hereof, the mounting assembly 200 and the battery 100 configured with the mounting assembly 200 may be positioned on the chassis 104 generally behind the cabin 106 of the truck 102. In one exemplary implementation hereof, the mounting assembly 200 may be configured on the chassis 104 of the truck 102 directly behind the cabin 106 of the truck 102 as shown in FIG. 5.

In this configuration, the weight of the battery 200 may not significantly alter the general center of gravity of the semi-trailer truck 102. This may ensure that the truck 102 remains balanced and stable when the battery 100 is configured on the truck 102. In addition, while in an upright orientation as descried, the battery 200 may not encompass a significant amount of space. That is, the footprint of the battery 100 and the associated mounting assembly 200 may be small compared to the overall footprint of the truck 102. In this way, the semi-trailer truck 102 may accommodate a storage container 110.

The mounting assemblies 200 may be configured with the vehicles 102 during the manufacturing of the vehicles 102, may be retrofitted to the vehicles 102 after the initial manufacturing of the vehicles 102, or configured with the vehicles 102 in any combination thereof.

The battery pack 100 may be removed from the mounting assembly 200 by opening at least one side of the frame 202, e.g., by Unlocking the locking mechanism 230 on one side, Unlocking the top locking mechanism 232 (if it exists) and sliding, lifting or generally moving the enclosure 108 out of the area A1 of the frame 202. In one exemplary embodiment hereof, an installation/removal mechanism 234 such as a fork lift may be used to reach, grip, hold and remove the battery pack 100 from the frame 202. The installation/removal mechanism 234 may include a fork lift that may be specifically designed and/or modified to securely engage with the battery pack 100 so that the battery pack 100 may be adequately supported and safely removed from the mounting assembly 200.

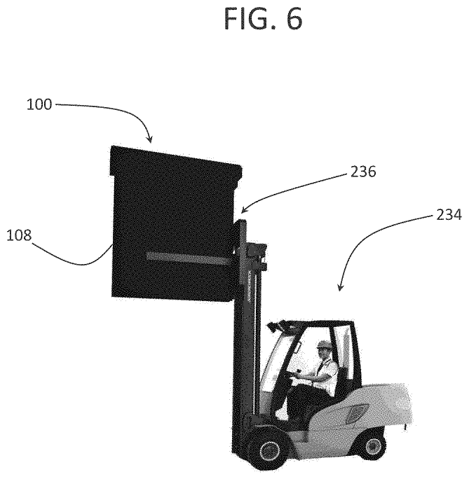

In one exemplary embodiment hereof, the fork lift 234 may include a specifically designed and/or modified fork 236 that may securely provide support to the sides and bottom of the battery pack 100 so that the fork lift 234 may reach into the mounting assembly 200, take hold of the battery pack 100, and safely slide, lift or otherwise remove the battery pack 100 from the mounting assembly 200. This is shown in FIG. 6. Other types of installation/removal mechanisms 234 such as conveyers, cranes or other types of removal mechanisms 234 may also be used and are contemplated in this specification.

It is understood by a person of ordinary skill in the art, upon reading this specification, that the above description of the mounting assembly 200 is meant for demonstration and conceptual purposes, and that the described mounting assembly 200 does not limit the scope of the mounting assembly 200 or the system 10 in any way. It is also understood that the specific elements of the mounting assembly 200 are described for conceptual purposes and that the mounting assembly 200 may include other elements or components not described, and/or may not include one or all of the elements described above. It is Understood that the mounting assembly 200 may include any general form, shape or structure that may secure the battery pack 100 to the truck 102, and that the exact form, shape or structure of the mounting assembly 200 does not limit the scope of the mounting assembly 200 or the scope of the system 10 in any way. It may be preferred that the mounting assembly 200 generally hold, secure and configure the battery pack 100 in a generally vertically upright configuration, but that the exact form of the mounting assembly 200 is not limited to the above described structures or forms. For example, the mounting assembly 200 may include front and rear plates in addition to or instead of the front and rear frame sections 104, 106. In this example, the front and rear plates may be solid wall structures such that the structures may not include left and right upright frame sections 208, 218 and 210, 220 respectively, top sections 212, 222, bottom sections 214, 224 or cross sections 216, 226. In another example, the frame 202 may be enclosed on all four vertical sides (front, back, left and right) and the battery pack 100 may be lifted vertically out the top of the frame 202 by a crane. It is clear that the described examples are all meant for conceptual purposes and that the mounting assembly 200 may take any form that may allow the mounting assembly 200 to perform its functionalities as required by the system 10.

It is also Understood by a person of ordinary skill in the art that if the system 10 includes different types or versions of battery packs 100, that each version or type of battery pack 100 may include a corresponding mounting assembly 200. In this case, each corresponding mounting assembly 200 may include the necessary dimensions, structures, forms, shapes and sizes required to fulfill it functionalities as required by the each battery pack 100 and the system 10, and the mounting assemblies 200 need not match. Accordingly, the system 10 may include a variety of different types and versions of mounting assemblies 200 with each type and version of mounting assembly 200 corresponding to an associated type of battery pack 100. It is clear that the different mounting assemblies 200 may or may not match in shape, size, form, dimensions or in any other characteristics or any combinations thereof.

It is also appreciated that the installation/removal mechanism 234 may include other types of removal mechanisms 234 such as conveyers, cranes or other types of removal mechanisms 234 or combinations of types of installation/removal mechanisms 234, and that the types, forms and structures of the installation/removal mechanisms 234 used do not limit the scope of the installation/removal mechanism 234, the mounting assembly 200, the battery pack 100 or the system 10 in any way.

### The Battery Charging Facilities

In one exemplary embodiment hereof, the system 10 may include one or more charging facilities 300 that may charge and/or recharge the battery packs 100. The charging facilities 300 may also provide maintenance and repair to the battery packs 100 as necessary.

In one exemplary embodiment hereof, the charging facilities 300 may include power supply charging racks 302 that may each include a multitude of power supply charging bays 304. Each charging bay 304 may be adapted and configured to physically and electrically receive at least one battery pack 100 (enclosed within its corresponding battery enclosure 108). In this way, the battery pack 100 may be charged by the charging bay 304.

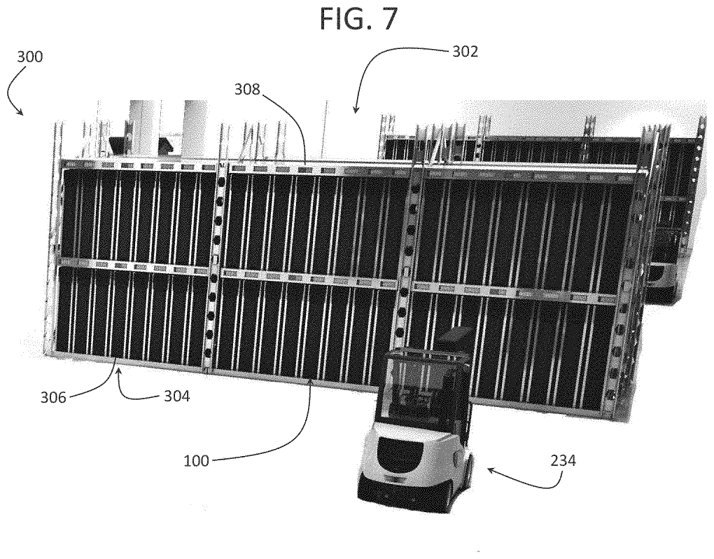

In one exemplary embodiment hereof, each charging facility 300 may include multiple levels of charging racks 302 (e.g., vertically stacked) as shown in FIG. 7. Each level of charging racks 302 may include multiple charging bays 304. In one exemplary implementation hereof, each charging facility 300 may include two levels of charging racks 302 with each level including twenty-four charging bays 304. In this way, the charging facility 300 may include forty-eight total charging bays 304. In addition, the charging facility 300 may include multiple vertically stacked racks 302 of charging bays 304 such that the totally number of charging bays 304 may be increased. Expanding on the example above, the charging facility 300 may include three vertically stacked charging racks 302 such that the total number of charging bays 304 may be tripled to 144. It is Understood that the above example is meant for demonstrational purposes and that any number of charging racks 302 and/or charging bays 304 may be used in any charging facility 300. It is also understood that different charging facilities 304 need not include the same number of charging racks 302 and/or charging bays 304.

The battery pack charging facilities 300 may also each include one or more installation/removal apparatuses 234 for use in installing and removing the battery packs to and from the charging bays, and to and from the transport system 400 (as will be described in later sections).

As shown in FIG. 7, the charging bays 304 may include front openings 306 that may each receive a corresponding battery pack 100. In this way, the battery packs 100 may be installed into the charging bays 304 from the front using the installation/removal mechanism 234 (e.g., a forklift). Accordingly, it may be preferable that the bays 304 include the proper dimensions to adequately receive and accommodate each battery pack 100 that may be installed into each bay 304. It is Understood that the different charging bays 304 need not match in size, shape, form or dimensions such that different charging bays 304 may accommodate and charge different battery packs 100 of different sizes, shapes, forms or dimensions.

The installation/removal mechanism 234 (e.g., fork lift) may generally position and insert the battery pack 100 through the front opening 306 and into its desired charging bay 304. It may be preferable that the charging bay 340 include cutouts, openings, slots or other elements that may allow for the fork lift 234 to insert its fork 236 (holding the battery pack 100) into the charging bay 304, place the battery pack 100 within the charging bay 304, release the battery pack 100 from its fork 236, and remove its fork 236 from the bay 304. The fork lift 234 may remove the battery pack 100 from the charging bay 304 by generally following the reverse procedure.

Note that other installation/removal mechanisms may also be used to install or generally position or insert a battery pack 100 into a charging bay 304. For example, the battery pack 100 may be inserted into a charging bay 304 using a conveyer, a crane, or any other type of mechanism of combination of mechanisms. The batteries 100 may also be installed into the charging bays 304 from the top, the sides or from any other direction. In this case, the charging bays may include the appropriate openings to receive the batteries 100.

Once installed within a charging bay 304, the battery pack 100 may be generally secured within the charging bay 304 so that it may not fall out of the charging bay 304 inadvertently.

With the battery pack 100 installed within the charging bay 304, the battery pack 100 and the charging bay 304 may be electrically connected via a physical electrical connection or a wireless electrical connected, or any combination thereof. It may be preferable that the battery pack 100 and the charging bay 304 be electrically connected using the same or similar components, elements and methods as described above with relation to the electrical connection between the battery pack 100 and the BEV 102 (the semi-trailer truck). For example, this may include positive and negative terminals on the battery pack 100 being connected to corresponding positive and negative terminals within the charging bay 304, corresponding metal coils on the battery pack 100 and the charging bay 304 for inductive coupling, corresponding metal electrodes on the battery pack 100 and the charging bay 304 for capacitive coupling, or by any other means or any combinations thereof. It is Understood that each charging bay 304 may include one or more electrical connection elements as described to accommodate different battery packs 100 with different types of electrical connections element requirements. In addition, each charging bay 304 need not include the same electrical connection elements as any other charging bay 304. In this way, the charging facility 300 may include different types of charging bays 304 that may accommodate and charge different types of battery packs 100.

It may be preferable that the battery packs 100 and the corresponding charging bays 304 be automatically electrically connected upon the installation of the battery packs 100 into the charging bays. However, manual connection may also be required.

Once configured with the battery packs 100 and connected electrically, the charging bays 304 may each provide the required electrical current (measured in amperage or amps) to each corresponding battery pack 100 in order to adequately charge each battery 100.

The charging facility 300 may be connected to the local electrical grid to receive the power necessary to run the facilities 300 and to charge the battery packs 100. In addition, the charging facility 300 may also include generators, solar panels, wind turbines or other types of energy producing devices or mechanisms that may provide additional power to the charging stations 300 to power the stations 300 and to charge the battery packs 100. In addition, the charging facilities 300 may each include other components and elements (e.g., power transformers) that may be required for the charging facilities 300 to perform their required functionalities.

Each charging rack 302 and/or charging bay 304 may include one or more charge identifiers 308 that may generally indicate whether or not an installed battery pack 100 within a particular charging bay 304 may be charging or not. This may ensure that the operators of the facility 300 have knowledge as to what batteries 100 may be charging and what batteries 100 may be experiencing problems. The indicators 308 may also display information regarding the level each battery's charge, when the battery 100 may be fully charged, as well as other information. The indicators 308 may be lighted meters that may display red, yellow and green lights that may each represent different levels of charge. For example, red may indicate a low charge or a problem, yellow may represent a medium charge and green may represent a full charge. The indicators 308 may also include numerical readouts that show the level of charge, the amount of current being drawn by the each battery pack 100 as well as other information. It is clear that the indicators 308 may take any form that may be adequate to relay the desired information regarding the charging of the batteries 100.

The system 10 may include charging facilities 300 in different locations that may thereby serve different locales. For instance, it may be preferable for the system 10 to include charging stations 300 sequentially spread across the area of desired coverage (e.g., the United States or other countries). In this way, each charging facility 300 may service users, exchange centers 500 and drained battery packs 100 within a general radius of its location.

In one exemplary implementation, the system 10 may include charging facilities 300 spread over an area of coverage at a spacing of every 250 miles. In another exemplary implementations, the system 10 include charging stations located at a spacing of every 150 miles, 200 miles, 300 miles, 400 miles, 500 miles and at other spacings or combinations of any spacings as required. It is understood that the spacing between different charging stations 300 may not match and that the location of the charging facilities 300 may also depend on other factors in addition to the spacings including but not limited to: the availability of land, availability of power, population density as well as other factors.

### The Battery Exchange Centers

In one exemplary embodiment hereof, the system 10 may also include battery pack exchange centers 500. In one exemplary embodiment, the system 10 may include one or more battery pack exchange centers 500-1, 500-2, . . . 500-n (collectively and individually battery exchange center(s) 500) that may generally stock a number of fully charged battery packs 100.

The battery pack exchange centers 500 may stock the fully charged battery packs 100A in easy to access racks or other structures. The racks may be stacked vertically in order to optimize the storage space available at the centers 500. The fully charged battery packs 100A may be available to users of BEVs 102 (e.g., semi-trailer trucks) that may wish to exchange a drained battery 100B from their vehicles 102 for a newly charged battery 100A in a convenient, safe and fast fashion.

The battery pack exchange centers 500 may each include one or more installation/removal apparatus 234 that may remove the drained battery pack 100B from the user's truck 102, and replace it with a charged battery pack 100A from the center's inventory of charged battery packs 100A. The drained battery pack 100B may then be inventoried, stored, prepped and scheduled for pick-up for transport to the local charging facility 300 to be recharged.

It may be preferable that one or more battery exchange stations 500 be located within the service radius of each charging facility 300 such that the charging facility 300 may service the battery exchange centers 500 by picking up drained batteries 100B that the exchange stations 500 may receive from their customers, and replacing them with charged batteries 100 from the charging facility 300. The drained batteries picked up from the exchange stations 500 may then be taken to the charging facility 300 to be charged and subsequently returned to the exchange station for redeployment to the station's customers.

The steps taken by a user to exchange their drained battery 100B for a charged battery 100A may include:
1. Receive an indication from their BEV 102 that the BEV's battery pack 100 may be low on stored energy.
2. Drive their BEV 102 to a local battery exchange station 500.
3. Have the drained battery 100B removed from their BEV 102. It may be preferable that the drained battery 100B be removed using an installation/removal mechanism 234 (e.g., a fork lift) by an exchange center operator.
4. Have a charged battery 100A installed into their BEV 102. It may be preferable that the charged battery 100A be installed using an installation/removal mechanism 234 (e.g., a fork lift) by an exchange center operator.
5. Receive indication from the BEV 102 that the charged battery 100A is properly configured with the BEV 102, that the battery 100A is charged, and that the BEV 102 is ready for use.

It is Understood that the steps described above are meant for demonstration purposes and that other steps may also be necessary to exchange a drained battery 100B for a charged battery 100A. In addition, not all of the steps described above may be necessary.

Note that the user may be required to pay or otherwise reimburse the exchange center 500 for the battery pack 100 exchange. The payment may be in the form of a one-time payment, a multi-exchange payment (with credits to use), a subscription based payment plan, an unlimited exchange payment plan, or using any other payment method or plan or any combination thereof.

As will be described in more detail below, the drained batteries 100B received from the users may be picked up and transported to a battery charging facility 300 by the transport system 400.

Note also that the exchange centers 500 may include charging racks 302 and charging bays 304 so that the exchange centers 500 may recharge the depleted batteries 100B that it may receive from its customers as required. The charging racks 302 may include all of the functionalities as describe in relation to the charging racks 302 above with reference to the charging facilities 300. It may be preferable that the exchange stations 500 only include a limited number of charging bays 304 to charge batteries 100B, and that the majority of the recharging of the drained batteries 100B may be performed at the charging facilities 300. However, the exchange stations 500 may include any number of charging racks 302.

### The Battery Transport System

In one exemplary embodiment hereof, the system 10 may include a transport system 400. The transport system 400 may generally transport charged battery packs 100A from the battery charging facilities 300 to the battery exchange stations 500, and drained batteries 100B from the battery exchange stations 500 to the battery recharging facilities 300. The transport system 400 may also transport charged batteries directly to end users as necessary.

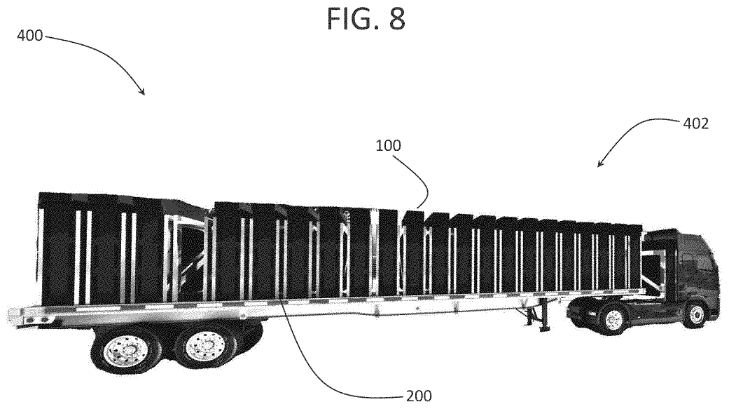

In one exemplary embodiment hereof and as shown in FIG. 8, the transport system 400 may include one or more semi-trailer trucks 402 equipped with at least one battery pack rack 404 (or other type of support structures) adapted to carry, hold, delivery and generally transport battery packs 100 (whether charged battery packs 100A, drained battery packs 100B, or any combination thereof) from one location to another. It may be preferable that the transport racks 404 include the proper dimensions, shapes, structures and forms to accommodate the different battery packs 100 that the transport system 400 may be required to transport.

In one exemplary embodiment hereof, the battery pack racks 404 may include a combination of mounting assemblies 200 or other types of battery holders configured in a series as shown in FIG. 8. In this way, the battery pack racks 404 comprising mounting assemblies 200 (e.g., frames 202 as well as the other structures and components of the mounting assemblies 200 as appropriate) may be configured with the transport trucks 402 to safely carry and transport the battery packs 100. It may be preferable for the series combination of mounting assemblies 200 to be mounted to the chassis of the transport truck 402 as shown for stability and balance.

In addition, the procedure to install (load) the battery packs 100 onto the transport trucks 402 and into the battery pack racks 404 for transport may be the same or similar to the procedure to install (load) the battery packs 100 into a mounting assembly 200 on a truck 102 for use in providing energy to the truck 102 as described above. However, in the case of the battery pack rack 402, there may be no need for an electrical connection between the battery packs 100 and the transport truck 402. Also, the procedure to remove (Unload) the battery packs 100 from the transport trucks 402 and from the battery pack racks 404 may be the same or similar to the procedure to remove (Unload) the battery packs 100 from the mounting assembly 200 on a truck 102 in order to replace the battery pack 100 with a charged battery 100A to power the truck 102 as described above. Note that other types of racks, mounting systems and assemblies and/or other structures may also be used to secure the battery packs 100 to the transport truck 402 for transport from one location to another, and that the type, form, shape or dimensions of the battery pack racks 404 used does not limit the scope of the transport system 400 or the system 10 in any way. It is also understood that each transport truck 402 may include different types of battery pack racks 404 that may carry different types and numbers of battery packs 100, and that the different battery pack racks 404 need not match.

In one preferred implementation, a transport truck 402 may include twenty-two mounting assemblies 200 in series such that the transport truck 402 may transport up to twenty-two battery packs 100. However, it is understood that the transport trucks 402 may include any number of mounting assemblies 200 or any other types of battery holding structures in order to transport any number of battery packs 100. It is also understood that not all of the mounting assemblies 200 configured with each transport truck 402 may be utilized at any given time.

In one preferred implementation, the transport system 400 may deliver charged battery packs 100A to the exchange stations 500, and at the same time, pick up drained battery packs 100B from the exchange stations 500 to transport to a charging facility 300 for charging. It may be preferable that the transport system 400 delivery charged batteries 100A and pick up drained batteries 100B during the same trip to each exchange station 500, however, this may not be necessary. In one preferred implementation, the transport truck 402 may embark from a charging facility 300 in the morning stocked with charged battery packs 100A, and travel to one or more exchange stations 500 throughout the day, dropping off charged battery packs 100A and picking up drained battery packs 100B at each station 500.

The transport trucks 402 may generally visit and service exchange stations 500 that may be within the service radius of the charging facility 300 that each transport trucks 402 may support. However, it is understood that a transport truck 402 may visit any exchange station 500 as required. When the transport truck 402 may be out of charged batteries 100A and stocked full of drained batteries 100B, the transport truck 402 may return to the charging facility 300 to Unload the drained battery packs 100B and restock with charged battery packs 100A.

As will be described in later sections, the system 10 may have real time data and information regarding each exchange station's inventory of charged and drained batteries 100A, 100B respectively so that the transport system 400 may be able to deliver the number and type of each battery pack 100 that each exchange station 500 may require on a given day.

It may be preferable that the system 10 include an adequate number of exchange stations 500 within each service radius of each charging facility 300 to ensure adequate service to all of the users who may require the ability to exchange their drained batteries 100B for charged batteries 100A at any given time.

Depending on the service radius of the charging facilities 300 and the number of exchange stations 500 within each service radius, the transport system 400 may include more than one transport truck 402, with each transport truck 402 visiting different sets of exchange stations 500 in order to adequately service each exchange station 500. In this way, each exchange station 500 may stock an adequate number of charged battery packs 100A to serve its customers at any given time.

In one exemplary embodiment hereof, the transport trucks 402 may deliver charged battery packs 100A directly to end users who may not have the ability to visit an exchange station 500 directly (e.g., users whose BEVs 102 may have run out of stored energy and that may not be able to travel to an exchange station 500). The user may notify the system's transport system 400 and schedule the direct delivery. In this case, it may be preferable for the transport truck 402 to be a smaller transport truck 402 that may carry a lesser number of charged battery packs 100. The transport truck 402 may travel directly to the end user in need, deliver the charged battery pack 100A, remove the user's drained battery pack 100B from the user's truck 102, install the charged battery pack 100A into the user's truck 102, install the drained battery pack 100B into its battery pack rack 404, and deliver the drained battery pack 100B to the charging facility for recharging. It may be preferable that the transport truck 402 that may deliver charged battery packs 100A directly to end users include a installation/removal apparatus 234 such as a manual fork lift or other type of installation/removal apparatus 234. The method by which the end user may notify the system 10 of the need for a direct delivery, or the method by which the system 10 may predict the need for a direct delivery, will be described in later sections.

### The Control Platform

In one exemplary embodiment hereof, the system 10 may include a control platform 600 that may provide resources and/or mechanisms to support the system 10, the battery, the rechargeable battery(s) 100, the charging facility(s) 300, the battery transport system 400, the battery exchange stations 500, as well as other aspects of the system 10 such as the manufacturing, procurement, inventorying, maintenance, repair, deployment, tracking, receiving, disposal, restocking and other aspects and elements of the rechargeable battery(s) 100 and the system 10 as necessary. The control platform 600 may also perform other functionalities such as data collection, data mining and analysis, reporting and other functionalities.

As depicted in the drawing in FIG. W, the rechargeable battery(s) 100, the charging facility(s) 300, the battery transport system 400 and the battery exchange stations 500 may each, alone or in combination, be in communication with the control platform 600 (also referred to as the backend platform 600). In this way, the rechargeable battery(s) 100, the charging facility(s) 300, the battery transport system 400 and the battery exchange stations 500 may all be in communication with each other via the backend platform 600. The communication may occur through a network 602 that may include the Internet, telephony networks, Wi-Fi networks, LAN, WAN, wireless networks, or any other type of communication networks or protocols, or combinations of communication networks or protocols.

It is clear that the various elements, components and systems of system 10 may all communication with each other via the network 602 and the backend 600. It is also Understood that the types of networks 602 used by the various elements of the system 10 need not match the types of networks 602 used by other elements of the system 10, and that any element of the system 10 may use any type of network 602 or combinations of networks 602 as required.

The backend platform 600 may include one or more servers that may include CPUs, memory, software, operating systems, firmware, network cards and any other elements and/or components that may be required to the backend platform 600 to perform its functionalities.

Embodiments or implementations of the backend platform 600 may include some or all of the functionalities, software, algorithms and mechanisms necessary to collect, communicate, correlate, process, analyze, report and otherwise use all of the data from the system 10.

In one exemplary embodiment hereof, an exchange station 500 may communicate to the charging facility 300 and/or the transport system 400 its current inventory of depleted batteries 100B and fully charged batteries 100A. The exchange station 500 may also communicate the types of batteries 100A that it may require for its customers upon the next delivery of batteries by the transport system 400, and/or the types of batteries 100B that may need to be picked up. In this way, the transport system 400 may deliver the required charged batteries 100A to and remove the drained batteries from the exchange center 500, and the exchange center 500 may keep its required batteries 100A in stock.

In another exemplary embodiment hereof, the backend 600 may collect usage data from the exchange centers 500 and/or the transport system 400 such as the number and types of batteries deployed by any given exchange center 500 or by any set of exchange centers 500 in a particular locale. In this way, the backend 600 and the system 10 may analyze the data to determine trends of usage and to predict future needs. For example, the backend system 600 may mine the data and determine that additional exchange centers 500 may need to be deployed in areas of high usage to accommodate the demand for recharged batteries 100A.

In another exemplary embodiment hereof, each battery 100 and/or battery housing 108 may include a communication mechanism that may allow the battery 100 and/or housing 108 to communicate directly with the backend system 600. Accordingly, the battery 100 and/or housing 108 may include an identifier such as a serial number, an IP address or other type of identifier so that the control platform 600 may identify each battery 100 and/or battery housing 108 individually as required. In this way, the control platform 600 may track the usage, the location, the energy level and other aspects of the batteries 100.

Each battery 100 and/or battery housing 108 may also include mechanisms that may determine aspects of the battery 100 such as the stored energy level of the battery 100, the predicted amount of distance the vehicle 102 may travel on the remaining stored energy of the battery 100, problems that the battery 100 may be experiencing, as well as other aspects of the battery 100. In this way, the battery 100 and/or the battery housing 108 may communicate these aspects of the battery 100 to the backend 600, and the backend 600 may in turn communicate the aspects to other elements of the system 10 as necessary.

In one exemplary embodiment hereof, the battery 100 may determine that it may be rUnning low on stored energy and that it may not have enough stored energy to travel to the nearest battery exchange center 500. In this case, the battery 100 may communicate this information to the backend 600 and the backend 600 may notify the charging facility 300 and/or the transport system 400 of this problem. The charging facility 300 and/or the transport system 400 may then contact the user of the battery 100 and schedule a direct delivery of a fully charged battery 100A directly to the user in need.

As shown in FIG. 1, individual users U1, U2, . . . Un may also communicate with the control platform 600 via mobile devices 604, computers or other types of devices. In one embodiment, the mobile device 604 may be a smart phone, a tablet computer, a laptop computer or any other type of mobile device. The mobile devices 604 may each include an application (e.g. a mobile app) or other type of software or webpage browser that may allow the devices to communicate with the control platform 600 via the network 602. In this way, the mobile devices 604 may also communicate with the batteries 100, the charging facility 300, the transport system 400 and the exchange centers 500 via the mobile app and the control platform 600. It may be preferable for the users Un to have a registered account with the system 10 and the control platform 600 so that the control platform 600 may be able to identify each individual user to manage their account, battery usage and delivery, and other information and data, but this may not be necessary.

In one exemplary embodiment hereof, the users Un may use the mobile app (or webpage) to schedule a battery exchange with a battery exchange center 500. In this way, the user may arrive at the exchange center 500 at the scheduled appointment time and quickly receive their new fully charged battery 100A. The user Un may also communicate directly with the transport system 400 to arrange for a direct delivery of a fully charged battery 100A at any time they may desire. The user Un may also report problems with their battery 100 to the system 10 and arrange for onsite service.

It is clear that the mobile app, software, websites, etc. may allow the user to generally interact with the system 10 and its various components and elements at any time to perform a wide variety of additional functionalities. It is Understood that the examples given above regarding the uses of the mobile app, software, website, etc. are meant for demonstrational and conceptual purposes and that the mobile app, software, websites, etc. may perform and allow for additional functionalities as well. For example, the user may pay their battery usage bills to the system 10 through the app, may review their usage data over desired windows of time, may earn points for usage that may be redeemed for prizes and/or free battery exchanges, receive promotions from local exchange centers 500 as well as other functionalities. It is clear that the example functionalities of the mobile app, software, websites, etc. described above do not limit the scope of the mobile app, software, websites, etc. or the system 10 in any way.

The backend platform 600 according to exemplary embodiments hereof may include services or mechanisms to support one or more of the following:
1. Track and manage inventory levels of the drained batteries 100B and fully charged batteries 100A at each exchange center 500.
2. Track deployment, usage, return, maintenance and redeployment of each individual battery 100 or groups of batteries 100
3. Collect and analyze user and usage data, including correlating user demographics, preferences, usage data, and any other data or information
4. Generate reports for all data gathered and all services rendered by the system 10 and its various system, elements and components.

It will be Understood by a person of ordinary skill in the art, upon reading this specification, that the functionality examples of the control platform 600 described herein are meant for demonstration purposes and that the control platform 600 may include any functionalities, operations and abilities that may be necessary for it to perform all of its functionalities required by the system 10, and that the functionalities listed do not limit the scope of the control platform 600 or the system 10 in any way.

### Computing

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and Understand, upon reading this description, that the various processes described herein may be implemented by, e.g., appropriately programmed general purpose computers, special purpose computers and computing devices. One or more such computers or computing devices may be referred to as a computer system.

FIG. 7 is a schematic diagram of a computer system 700 upon which embodiments of the present disclosure may be implemented and carried out.

According to the present example, the computer system 700 includes a bus 702 (i.e., interconnect), one or more processors 704, a main memory 706, read-only memory 708, removable storage media 710, mass storage 712, and one or more communications ports 714. Communication port(s) 714 may be connected to one or more networks (not shown) by way of which the computer system 700 may receive and/or transmit data.

As used herein, a “processor” means one or more microprocessors, central processing Units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 704 can be any known processor, such as, but not limited to, an Intel® Itanium® or Itanium 2® processor(s), AMD® Opteron® or Athlon MP® processor(s), or Motorola® lines of processors, and the like. Communications port(s) 714 can be any of an Ethernet port, a Gigabit port using copper or fiber, or a USB port, and the like. Communications port(s) 714 may be chosen depending on a network such as a Local Area Network (LAN), a Wide Area Network (WAN), or any network to which the computer system 700 connects. The computer system 700 may be in communication with peripheral devices (e.g., display screen 716, input device(s) 718) via Input/Output (I/O) port 720.

Main memory 706 can be Random Access Memory (RAM), or any other dynamic storage device(s) commonly known in the art. Read-only memory (ROM) 708 can be any static storage device(s) such as Programmable Read-Only Memory (PROM) chips for storing static information such as instructions for processor(s) 704. Mass storage 712 can be used to store information and instructions. For example, hard disk drives, an optical disc, an array of disks such as Redundant Array of Independent Disks (RAID), or any other mass storage devices may be used.

Bus 702 communicatively couples processor(s) 704 with the other memory, storage and communications blocks. Bus 702 can be a PCI/PCI-X, SCSI, a Universal Serial Bus (USB) based system bus (or other) depending on the storage devices used, and the like. Removable storage media 710 can be any kind of external storage, including hard-drives, floppy drives, USB drives, Compact Disc—Read Only Memory (CD-ROM), Compact Disc—Re-Writable (CD-RW), Digital Versatile Disk—Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 706 is encoded with application(s) 722 that support(s) the functionality as discussed herein (the application(s) 722 may be an application(s) that provides some or all of the functionality of the services/mechanisms described herein). Application(s) 722 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 704 accesses main memory 706 via the use of bus 702 in order to launch, run, execute, interpret or otherwise perform the logic instructions of the application(s) 722. Execution of application(s) 722 produces processing functionality of the service related to the application(s). In other words, the process(es) 724 represent one or more portions of the application(s) 722 performing within or upon the processor(s) 704 in the computer system 700.

It should be noted that, in addition to the process(es) 724 that carries(carry) out operations as discussed herein, other embodiments herein include the application 722 itself (i.e., the Un-executed or non-performing logic instructions and/or data). The application 722 may be stored on a computer readable medium (e.g., a repository) such as a disk or in an optical medium. According to other embodiments, the application 722 can also be stored in a memory type system such as in firmware, read only memory (ROM), or, as in this example, as executable code within the main memory 706 (e.g., within Random Access Memory or RAM). For example, application(s) 722 may also be stored in removable storage media 710, read-only memory 708, and/or mass storage device 712.

Those skilled in the art will understand that the computer system 700 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and Understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be Understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used herein, including in the claims, the term “portion” means some or all. So, for example, “A portion of X” may include some of “X” or all of “X”. In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, Unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

As used herein, including in the claims, the term “automatic,” with respect to an action, generally means that the action occurs with little or no human control or interaction. The term “automatic” also includes the case of no human control or interaction. Thus, e.g., the term “triggered automatically” means “triggered with little or no human control or interaction,” and includes the case “triggered with no human control or interaction.”

As used herein, including in the claims, singular forms of terms are to be construed as also including the plural form and vice versa, Unless the context indicates otherwise. Thus, it should be noted that as used herein, the singular forms “a,” “an,” and “the” include plural references Unless the context clearly dictates otherwise.

Throughout the description and claims, the terms “comprise”, “including”, “having”, and “contain” and their variations should be Understood as meaning “including but not limited to”, and are not intended to exclude other components Unless specifically so stated.

It will be appreciated that variations to the embodiments of the invention can be made while still falling within the scope of the invention. Alternative features serving the same, equivalent or similar purpose can replace features disclosed in the specification, Unless stated otherwise. Thus, Unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.”) and the like, is merely intended to better illustrate the invention and does not indicate a limitation on the scope of the invention Unless specifically so claimed.

Any acts described in the specification may be performed in any order or simultaneously, Unless the context clearly indicates otherwise.

All of the features and/or acts disclosed herein can be combined in any combination, except for combinations where at least some of the features and/or acts are mutually exclusive. In particular, preferred features of the invention are applicable to all aspects of the invention and may be used in any combination.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams Unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be Understood that the invention is not to be limited to the disclosed embodiment, but on the contrary, is intended to cover various modifications and equivalent arrangements included within the spirit and scope of the appended claims.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A system for providing charged power supplies, the system comprising:
at least one rechargeable power supply;
at least one recharging facility;
at least one transport system; and
at least one power supply exchange center;
wherein the at least one charging facility charges the at least one rechargeable power supply, and the at least one transport system transports the at least one charged rechargeable power supply from the at least one recharging facility to the at least one power supply exchange center.

2. The system of claim 1 wherein the at least one rechargeable power supply is a rechargeable battery.

3. The system of claim 2 wherein the charged rechargeable battery is configured with an electric vehicle to provide power to the electric vehicle.

4. The system of claim 3 wherein the charged rechargeable battery is configured with the electric vehicle by a mounting assembly.

5. The system of claim 4 wherein the height of the rechargeable battery is greater than the length of the rechargeable battery, and the mounting assembly secures the rechargeable battery in an upright position on the electric vehicle.

6. The system of claim 4 wherein the mounting assembly secures the rechargeable battery to the chassis of the electric vehicle.

7. The system of claim 4 wherein the electric vehicle is a truck with a cabin, and the mounting assembly secures the rechargeable battery to the truck directly behind the cabin.

8. The system of claim 1 further comprising a control platform in communication with the at least one transport system.

9. The system of claim 8 wherein the control platform receives information from the transport system regarding the delivery of the at least one rechargeable power supply.

10. The system of claim 8 wherein the control platform communicates with a user device.

11. The system of claim 10 wherein the user device receives information from the control platform and/or sends information to the control platform.

12. A method for providing at least one charged rechargeable battery for use with electric vehicles, the method comprising:
(A) charging the at least one rechargeable battery at a charging facility;
(B) transporting the charged at least one rechargeable battery to a battery exchange station; and
(C) configuring the charged at least one rechargeable battery to an electric vehicle;
wherein the charged at least one rechargeable battery is provided to a user.

13. The method of claim 12 wherein the configuring the charged at least one rechargeable battery in (C) further comprises:
(C)(1) configuring the charged at least one rechargeable battery to the electric vehicle with a mounting assembly.

14. The method of claim 13 wherein the configuring the charged at least one rechargeable battery in (C)(1) further comprises:
(C)(2) configuring the charged at least one rechargeable battery to the electric vehicle in an orientation where the height of the charged at least one rechargeable battery is greater than the length of the charged at least one rechargeable battery.

15. The method of claim 12 further comprising between steps (A) and (B):
(A)(1) communicating with a battery exchange station regarding the exchange station's inventory of charged at least one rechargeable batteries.

16. The method of claim 12 further comprising:
(D) receiving at least one drained rechargeable battery from the rechargeable battery exchange station; and
(E) transporting the at least one drained rechargeable battery to the recharging facility.

17. The method of claim 14 wherein the electric vehicle is a truck with a cabin, and the configuring of the charged at least one rechargeable battery in (C)(2) further comprises:
(C)(3) configuring the charged at least one rechargeable battery to the truck directly behind the cabin.

18. The method of claim 17 wherein the configuring of the charged at least one rechargeable battery in (C)(3) further comprises:
(C)(4) configuring the charged at least one rechargeable battery to the chassis of the truck.
